(19) United States
(12) Patent Application Publication
(10) Pub. No.: US 2010/0064676 A1
(43) Pub. Date: Mar. 18, 2010

(54) The Operation of a Pressure Generator

(76) Inventor: Luis Olvera Diaz, Queretaro (MX)

Correspondence Address: MILLER, MATTHIAS & HULL, ONE NORTH FRANKLIN STREET, SUITE 2350, CHICAGO, IL, 60606, US

(21) Appl. No.: 12/529,111

(22) PCT Filed: Feb. 25, 2008
(86) PCT No.: PCT/MX08/00026

§ 371 Date: Aug. 28, 2009

(30) Foreign Application Priority Data
Mar. 1, 2007 (MX) MX/U/2007/000093

(51) Int. Cl. F16D 31/02

(52) U.S. Cl. 60/409

(57) ABSTRACT

The invention relates to a pressure generator and to the novel features thereof, which is intended to multiply pressure output through the use of sealed chambers containing rodless pistons acting on the fluid which operates as a force transmitter and concentrates the force on the frusto-conical covers at each end of the piston. Owing to the taper of the covers, the force is directed toward the directional valves which are housed in the ends of the piston and distribute the pressure in an orderly manner through fluid conductors towards the hydraulic motor. The operation and novel features of said generator render these systems more efficient.

### FIELD OF THE INVENTION

Optimization of available energy provided by a pressure generator, to obtain a higher yield and power unlike conventional motors which are currently in the market and thus achieving a significant power saving to perform any work.

The pressure generator comprises a hydraulic system which does not use rods in the plungers using the same fluid to transmit the required action force unlike other hydraulic systems. In former invention with registration number 2009006 granted by the Spanish Patent and Trademark Office, piston ends show frusto-conical caps with a pronounced conical shape wherein fluid is centered and concentrated to act as force transmitter. These cylinders are sealed and they present limit switches within; cylinder output pressure further feeds another cylinder obtaining a pressure increase.

### BACKGROUND OF THE INVENTION

Pressure generators may be used in a variety of applications, such as: engine replacements for automotive vehicles, industrial equipment, and generally where movement produced by an engine is required.

Likewise, other pressure generator advantages may be mentioned such as, no fuel consumption, extended autonomy, the oil being used as fluid also acts as a lubricant to minimize wear, and the pressure generator is pollution-free since no toxic gases or noise is emitted. The generator may perform large amounts of work using a minimum of electric or chemical energy.

By using the generator in industrial systems, up to 90% of electric power consumption may be saved by replacing large electric motors. The pressure generator presents a low manufacturing cost due to its construction features.

In order to perform the fluid directional changes which provide continuity to pressure generator performance, the original prototype uses electric elements which may fail due to wear over time. Therefore, in addition to electric elements in directional changes, mechanical, hydraulic, pneumatic elements, and compressed air were deemed useful since they were much more effective and durable.

It is worth mentioning that after using the original registration, the frusto-conical caps from the original registration disclosed within the text were found to be more effective in force transmission when they are manufactured with conicity from one degree or up to 120 degrees slope including all their subdivisions with minutes and seconds among themselves.

### BRIEF DESCRIPTION OF THE DRAWINGS

FIG. 1 is a diagrammatic lateral view of a piston (5);

FIG. 2 is a diagrammatic view of a fluid directional change system showing the action of one of the directional changes.

FIG. 3 is an ancillary diagram from FIG. 2, showing fluid directional changes during action one and action two.

### DETAILED DESCRIPTION OF INVENTION

A system to perform fluid directional changes was designed which provides generally continuous performance efficiency and thus provides a rotation that is as smooth as possible. The fluid directional change design further comprises electric elements, a hydraulic system, a mechanical system, a pneumatic system and compressed air, the elements being those which are below described.

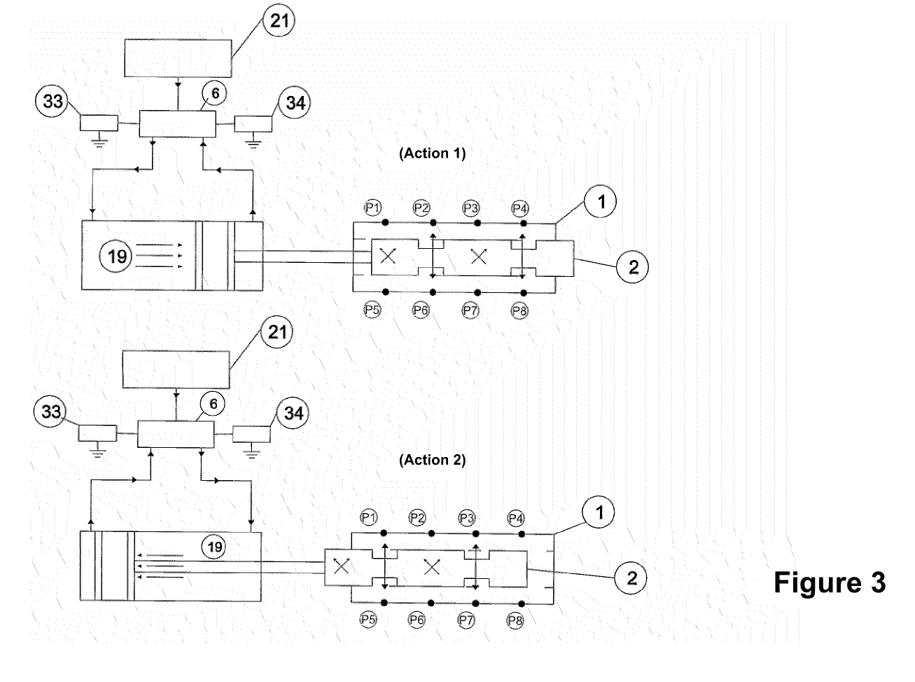

Four-way directional valve (1): The body forming the outer part of the valve (1) is an indistinct shape metal bar comprising a cylindrical longitudinal bore and eight threaded cylindrical transverse bores (P1, P2, P3, P4, P5, P6, P7, P8). FIG. 3.

Another element forming the valve (1) is a cylindrical metal bar (2) which is known as a spool. It has two notches whereby fluid will pass freely towards valves (29) and (30), spools (27) and (28) are intended to be changed thus modifying the plunger direction (22) towards the A or B position. The spool (2) may slide through a longitudinal hole formed in the body valve (1) to allow or prevent fluid flow therethrough as shown in FIG. 3.

Fluid change performance is described below.

Unlike original prototype directional change performance, directional changes are electrically and hydraulically performed. The new fluid directional change system is performed with a hydraulic system, a mechanical system, a pneumatic system and compressed air in addition to electric elements; other new elements in this system are limit switches (3) and (4) arranged externally and each one is arranged on each piston end (5), these elements being in charge of transmitting an electric signal to the electrovalve (6).

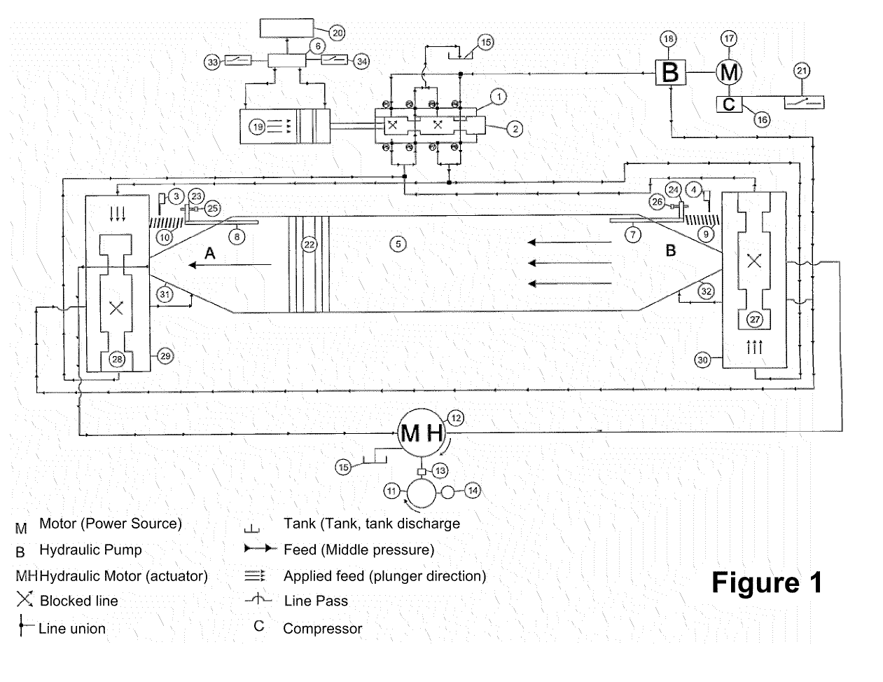

Another novelty with this invention is the metal bars (7) and (8) which are located on each piston end (5). One of the bar ends (7) and (8) penetrates within piston (5). See FIG. 1. The other ends of bars (7) and (8) are pushed and forced to be kept within piston (5) even under pressure conditions, due to the pressure exerted by springs (9) and (10) over bars (7) and (8). Another novelty with this system is a counterweight rotor (11) which is connected through a pulling coupling (13) to the hydraulic motor output shaft (12) having a function of absorbing power failures.

When the system performs directional changes, rotation of the hydraulic motor (12) tends to decrease, said variation not being performed by rotor (11) action since it is triggered by the hydraulic motor (12) through a coupling (13) with a sprocket system, this system allowing the rotor (11) to continue to freely and independently rotate, thus preventing power and revolution drops. When the system performs fluid directional changes, the hydraulic motor (12) may eventually not receive power and thus tend to shut down and decrease its revolutions.

Another novelty is the air compressor (16) which is operated by the main source motor (17). The compressor (16) provides compressed air in order to operate the pneumatic piston (19) through the electrovalve (6) in combination with limit switches (3) and (4) and air tank (20).

Another novelty is the use of a tachometer (14) located in the output power intake. This will allow to the system user to verify and to control the output revolutions per minute.

When the pressure generator system is started up, the compressor (16) which provides compressed air to the tank (20) is simultaneously operated, and has an electromechanical pressure gauging system known as pressostat (21) comprising check feed valves and a manometer.

When the gauged pressure is reached, the pressostat (21) shuts the compressor electric circuit (16), thereby shutting it down until pressure is decreased. Once more, pressostat (21) shuts the electric circuit and the compressor (16) provides air to the tank (20), thus successively until the whole system is shut down.

When the desired air pressure is obtained in the pressostat (21), it sends an electric signal to the hydraulic motor speed control electromechanical system further shutting the compressor circuit (16), and then to the rotating rotor (11) by a pulling coupling with sprocket mechanism (13) at the desired gauged speed.

When the above operations have been performed, the piston (5) part A and/or B receives fluid feed and pressure tends to displace plunger (22) towards the opposite part to the side receiving piston (5) feed (A or B), until plunger (22) before reaching its displacement limit contacts bar (7 or 8) pushing it outside piston (5) and overcoming the spring force (9 or 10); a small metal bar (23 and 24) is located on the bar ends (7 or 8) disposed outside of the piston (5), and have a side bore which allows a screw (25 and 26) arrangement with a back nut to provide the desired fixation to screws (25 and 26) whether for cutting or enlarging screws (25 and 26). Very close to the screws (25 and 26), the limit switches (3 and 4) are located which operate by a close contact and to transmit an electric signal to the four-way electrovalve (6) when the plunger (22) pushes the bar (7 or 8), this makes contact by a gauging screw (25 or 26) with the switch (3 or 4) to close the electric circuit and energize the electrovalve solenoid (33 or 34), which in turn supplies compressed air to the pneumatic piston (19) operating to push or to retract spool (2) from the hydraulic directional valve (1), this receiving fluid feed from the pump (18) and sending it through feed line up to the valves (29) and (30) forcing the spools (27 and 28) to displace within valves (29) and (30) thus performing the displacement change in an opposite direction to plunger (22). Note that at each piston end (5) of the above described elements are equally located. See FIG. 1.

It is worth to mention that once that plunger (22) is retracted back to side (A) or (B) of the piston (5), the above-mentioned operation is successively performed thus providing continuity for the fluid feed to hydraulic motor (12) to function without interruption. The four-way electrovalve (6) operated by solenoids (33) or (34), receives compressed air feed from the air tank (20) and it is scheduled according to the desired performance to operate plunger (22) for displacement towards piston (5) side (A) or (B). It is important to mention that generally the system may use one or several pistons and on each of them the same above mentioned elements may be used in number excluding the compressor (16), pump (18), hydraulic motor (12), tachometer (14), coupling (13), rotor (11) and power source (17) since when more than one piston is required, all fluid supplied by pistons will be moved to the hydraulic motor (12) in order to provide more power to the system. Having been already described, the pressure generators have a directional valve (29) or (30) for each piston end (5) which operate with a hydraulic force provided from the hydraulic valve (1) which is fed by the pump (18). With this force, the spools (27) and (28) are displaced within valve body (39) and (30). See FIG. 1. The valves (29) and (30) may be two-way type. When the spools (27) and (28) are provided with two notches each (one at each valve end (29) and (30)), one of the valves (29) or (30) opens or closes the piston feed and at the same time it closes or opens the displaced fluid by plunger (22) towards the hydraulic motor (12).

Fluid supply from the two-way directional valves (29) and (30) is provided by the pump (18) through hydraulic conduits (hoses) up to the four-way directional valve (1) which distributes fluid to the directional valves (29) and (30) arranged for each of the piston ends (5).

The directional valve (1) operates through bars (7) and (8) which penetrate by piston ends (5) through frusto-conical caps (31) and (32), these bars are forced to remain within the piston (5) by the spring force (9) and (10) in such a way that when the plunger (22) is displaced towards any end (A) or (B) of the piston (5), the plunger (22) pushes the bar (7) or (8) overcoming the spring force (9) or (10). Next, bar (7) or (8) makes contact with the limit switch (3) or (4), through the bar (23) or (24) and the screw (25) or (26), thus providing a directional change of the plunger (22) towards end (A) or (B) of the piston (5). The bars (7) or (8) are sufficiently long to perform the plunger (22) directional change before the plunger (22) reaches its displacement limit, thus continuity being present in fluid feed to the hydraulic motor (12) for uninterrupted system function.

### Plunger Directional Change

Plunger directional change (22) is performed by a hydraulic and pneumatic electromechanical system, together with the four-way directional valve (1) and compressed air, which operation is below described:

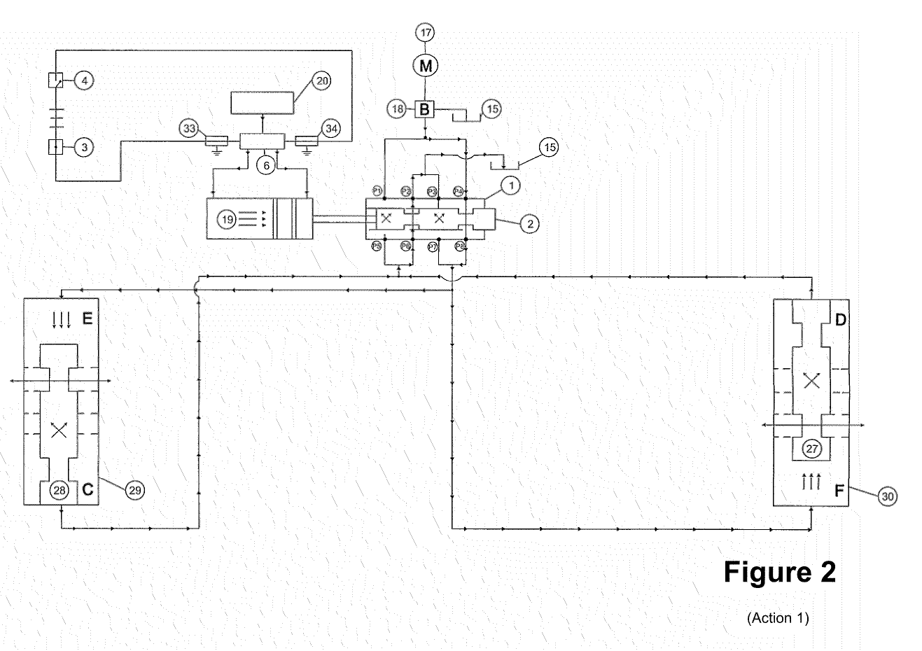

Action one: When the spool (2) is displaced by pneumatic piston action (19) (see action one in FIG. 3), the bores P2 and P6 are opened and connected with the fluid tank (15) for discharging the fluid which is enclosed within spaces C and D from the two-way directional valves (29) and (30). See FIG. 2.

At the same time, the holes P4 and P8 are connected to receive pressure feed, the fluid is sent to spaces E and F in the valves (29) and (30) to displace the spools (27) and (28) similarly, the piston (5) is fed in this way through the valve (30) and the hydraulic motor output (12) is cancelled in the same valve (30) see FIG. 1. At the same time, the piston feed (5) is blocked in the valve (29) and the piston (5) output hole is connected in the same valve (29) which connects to the hydraulic motor (12), thus providing feed to the hydraulic motor (12). In the same action (FIG. 1) holes P1 and P5, P3 and P7 are blocked.

Action two: When the spool (2) is displaced by the action of the pneumatic piston (19) in the action two position, holes P3 and P7 are connected to discharge the fluid which is enclosed in spaces E and F from the two-way directional valves (29) and (30) to the fluid tank. In the same position, P1 and P5 are connected to receive the pressure feed and to be sent to spaces C and D from the valves (29) and (30) to displace the spools (27) and (28). At the same time in this way, the piston feed hole (5) is opened within the valve, and the piston output (5) which feeds the hydraulic motor (12) is blocked. At the same time, in valve (30), the spool (27) blocks the feed hole to the piston (5) and the hole which connects the piston feed (5) to the hydraulic motor (12) is opened. In the same position, the P2 and P6, P4 and P8 holes in directional valve (1) are blocked. See FIG. 3.

### Frusto-Conical Caps

In this utility model design, frusto-conical caps (31) and (32) were used, tested and built with conicity from one degree or up to 120 degrees including all their subdivisions with minutes and seconds among them, obtaining higher efficiency results at maximum possible slope, these from one degree or up to 120 degrees with their respective subdivisions with minutes and seconds within them. This conicity allows concentrating the fluid transmitting force in the most effective way over the valve output (29) and (30), increasing the system efficiency.

1. A pressure generator with a hydraulic system in which a same fluid is used to transmit a required action force; having:
a piston defining a sealed cylinder with frusto-conical caps on opposite ends, the caps having a slope from one degree up to 120 degrees, which pronounced conicity centers and concentrates the fluid to actuate as a force transmitter;
limit switches at each piston end;
a compressed air system for performing directional changes of the piston, the compressed air system including bars, limit switches, a compressor, an air tank, gauging screw and pneumatic piston;
a directional valve device;
a counterweight rotor with a pulling coupling with sprocket mechanism; and
a tachometer for maintaining a constant rotating speed.

2. The pressure generator with hydraulic system according to claim 1, which frusto-conical caps have a slope, preferably from one degree or up to 120 degrees including all their subdivisions with minute and seconds between each degree.

3. The pressure generator with hydraulic system according to claim 1, which piston comprises an inner plunger, further having a four-way directional valve, a spool, an electrovalve and a change system which interact in two actions with the four-way directional valve, which controls the directional changes of a two-way directional valves.

4. The pressure generator with hydraulic system according to claim 1, which counterweight rotor together with the pulling coupling with sprocket mechanism provides a more efficient system performance at constant speed.

5. The pressure generator with hydraulic system according to claim 1, which tachometer monitors constant speed in these systems.
